(19) United States
(12) Patent Application Publication
(10) Pub. No.: US 2009/0316706 A1
(43) Pub. Date: Dec. 24, 2009

(54) STRUCTURED PREMISE NETWORKING SYSTEM

(75) Inventors: Mark Robert Hawley, Spokane, WA (US); Jeremy James Gallagher, Spokane, WA (US)

Correspondence Address: LEE & HAYES, PLLC, 601 W. RIVERSIDE AVENUE, SUITE 1400, SPOKANE, WA, 99201, US

(73) Assignee: Telect, Inc., Liberty Lake, WA (US)

(21) Appl. No.: 12/141,817

(22) Filed: Jun. 18, 2008

(51) Int. Cl. H04L 12/56

(52) U.S. Cl. 370/401

(57) ABSTRACT

A data network to manage the distribution of network services and content throughout a home or residence is described. Generally, the data network includes a media gateway to receive, manage, and distribute services and content throughout the residence. The media gateway may include a structured wiring panel, a services switch to manage the network, and a communications module to provide an interface between the services switch and the residence.

### BACKGROUND

The internet has become commonplace in today's homes and residences. Moreover, broadband internet service with its high transmission speeds has dramatically increased the number and types of computing devices that reside in the home (e.g., personal computers, printers, wireless routers, digital cameras, and storage devices, to name a few). In addition, today's internet service providers provide a variety of new services such as internet protocol television, voice over internet protocol, and other online services. Finally, inexpensive wireless routers make it possible to connect a variety of portable computing devices to the internet such as cellular phones, personal digital assistants, and even cars.

This dramatic increase in the number and types of computing devices has lead to highly complex and wide-ranging home data networks. Today's home may consist of more devices and offer more features than a small business network.

Although the average consumer has become more sophisticated and knowledgeable regarding computing and computer networks, the complexity of today's home computer networks has outpaced the average homeowner's knowledge. Today, the average homeowner lacks the requisite knowledge and experience to install and manage their home computer network and the associated networked devices.

In addition to the hardware and software aspects of home networks, the installation of wiring has also become complex. A typical home network may have internet connections in every room and data lines throughout the residence (e.g., CAT5, CAT6, to name a few). As a result of this installation complexity, manufacturers have developed structured wiring panels to organize and terminate these data lines. Although structured wiring panels greatly simplify the installation and termination of home networks, there is still room for improvement. Moreover, once the network has been installed, there is the ongoing issue of maintaining the home network.

Accordingly, there is a need for techniques and devices to simplify the installation and maintenance of residential data networks.

### SUMMARY

This summary is provided to introduce simplified concepts relating to residential data networks, which are further described below in the Detailed Description. The term “residential data network” should be interpreted broadly to include not only an occupant's home or residence, but also apartment complexes, town homes, small businesses, and the like.

In one aspect, an illustrative media gateway to distribute network services and content to a residence is described. In one embodiment, the media gateway may include a services switch located at the residence to receive network services from one or more network service providers, and to distribute the network services to a number of data outlets located at the residence. The services switch may include one or more processors, a network interface to receive instructions, a system database to store the received instructions, and a system manager to (i) selectively distribute the network services to the data outlets based on the received instructions, and (ii) selectively apportion available bandwidth to each of the data outlets based on the received instructions.

In another aspect, a method of managing bandwidth in a residential data network is described. In one embodiment, the method may include receiving network services at a media gateway located at a residence from one or more network service providers. The embodiment of the method may include configuring the media gateway to distribute the network services to a number of data outlets located at the residence. The media gateway may receive rules specifying which of the network services to distribute to each of the data outlets, and distribute the network services and content to each of the data outlets based on the received rules.

In another aspect, a method of supplying backup electrical power to devices in a residential data network is described. In one embodiment, the method includes receiving network services at a media gateway located at a residence from one or more network service providers. One example of the method may include configuring the media gateway to distribute the network services to a number of data outlets located at the residence. The media gateway may receive rules specifying which of the data outlets to supply backup electrical power to in the event of a main power failure. The media gateway may then select one or more of the data outlets to supply backup electrical power to, based on the rules entered. Further, the media gateway may assign a priority for receiving backup electrical power to each of the selected data outlets, also based on the rules entered, and then supply backup electrical power to one or more of the selected data outlets based on the priority determined for the data outlet, and based on the rules entered.

In another aspect, a media gateway to distribute network services and content to a residence is described. In one embodiment, the media gateway includes a structured wiring panel located at the residence. Further, the media gateway may include a services switch mounted within the structured wiring panel to receive network services from one or more network service providers, and to distribute the network services to a number of data outlets located at the residence. In one embodiment the services switch is physically accessible from within the residence. In a further embodiment, there are one or more patch panels mounted within the structured wiring panel to provide connectivity between the services switch and the plurality of data outlets, and an uninterruptable power supply (UPS) mounted within the structured wiring panel to supply backup electrical power to the services switch and/or one or more of the plurality of data outlets in the event of a main power failure.

In a further aspect, a method of managing the distribution of network services in a residential data network is described. In one embodiment, the method includes receiving network services at a media gateway located at a residence from one or more network service providers. Further, the media gateway may distribute the network services to a number of data outlets located at the residence. An illustrative media gateway is described as distributing the network services into a services switch within the media gateway, where the services switch is physically accessible from within the residence. The media gateway may then select one or more of the network services to distribute to one or more of the data outlets, and then route the selected network services through the services switch to the selected data outlets, therefore delivering the network services to devices connected to the data outlets.

In a final aspect, a method of supplying backup electrical power to devices in a residential data network is described. In one embodiment, the method includes electrically connecting an uninterruptable power supply (UPS) to a services switch, where both the UPS and the services switch are mounted within a media gateway located at a residence. In an example, the media gateway receives network services from one or more network service providers, and distributes the network services to a number of data outlets located at the residence. In a further embodiment, the method describes the media gateway selecting one or more of the data outlets to supply backup electrical power to in the event of a main power failure, and supplying backup electrical power from the UPS to devices coupled to the selected data outlets. In one embodiment, the media gateway assigns a priority to each of the selected data outlets, and supplies backup power to the selected data outlets based on the priority assigned to the data outlets.

While described individually, the foregoing aspects are not mutually exclusive and any number of aspects may be present in a given implementation.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a block diagram illustrating one example of how services and content may be delivered to a residence via an optical data network.

FIG. 2 is a schematic diagram depicting a residence with an illustrative data network.

FIG. 3 is a block diagram depicting an illustrative media gateway which may be mounted in a structured wiring panel.

FIG. 4 is a perspective view of an illustrative media gateway including a services switch mounted therein.

FIG. 5 is a perspective view of a services switch that may comprise a portion of an illustrative media gateway.

FIG. 6 depicts an example of a system database that may be used to store rules used in part to establish the priority of output ports.

FIG. 7 depicts one example of priority of a group of output ports, when apportioning bandwidth among the output ports.

FIG. 8 illustrates an example of a timeline showing how bandwidth may be apportioned between a group of output ports based on rules.

FIG. 9 depicts an illustrative method of apportioning bandwidth among a plurality of data ports.

FIG. 10 depicts an illustrative method of supplying backup power to critical network services in the event of a main power failure.

### DETAILED DESCRIPTION

### Overview

Due to the availability of high speed internet, the proliferation of inexpensive computing devices, and the broad offering of internet services, the average homeowner lacks the requisite knowledge and skill to install and manage today's residential data networks. Manufacturers have responded with products which simplify the installation of home networks (e.g., structured wiring panels, specialty wiring, and specialized electrical connectors, among others). While these solutions are helpful, they are inadequate given the sophistication of today's residential data networks. Moreover, these solutions are of limited usefulness in maintaining the residential data network once it has been installed.

This disclosure relates to various techniques to provide various digital services and content to a residence. Generally, the residential data network includes a media gateway to manage the distribution of internet services and content throughout the residence. The media gateway may include a structured wiring panel, a services switch to manage the digital services and content, and a patch panel to provide the communications interface between the services switch and the residence.

Generally, the media gateway manages the distribution, transmission, and quality of internet services and content provided throughout the home or residence. While the media gateway is described in the context of a home or residence, it is also applicable to an office, small business, or any other networked environment. This disclosure describes the media gateway in terms of a single structured wiring panel, containing a single services switch and one or more patch panels. However, the media gateway may also be configured as multiple structured wiring panels, with multiple services switches and multiple patch panels.

### Illustrative Media Gateway System

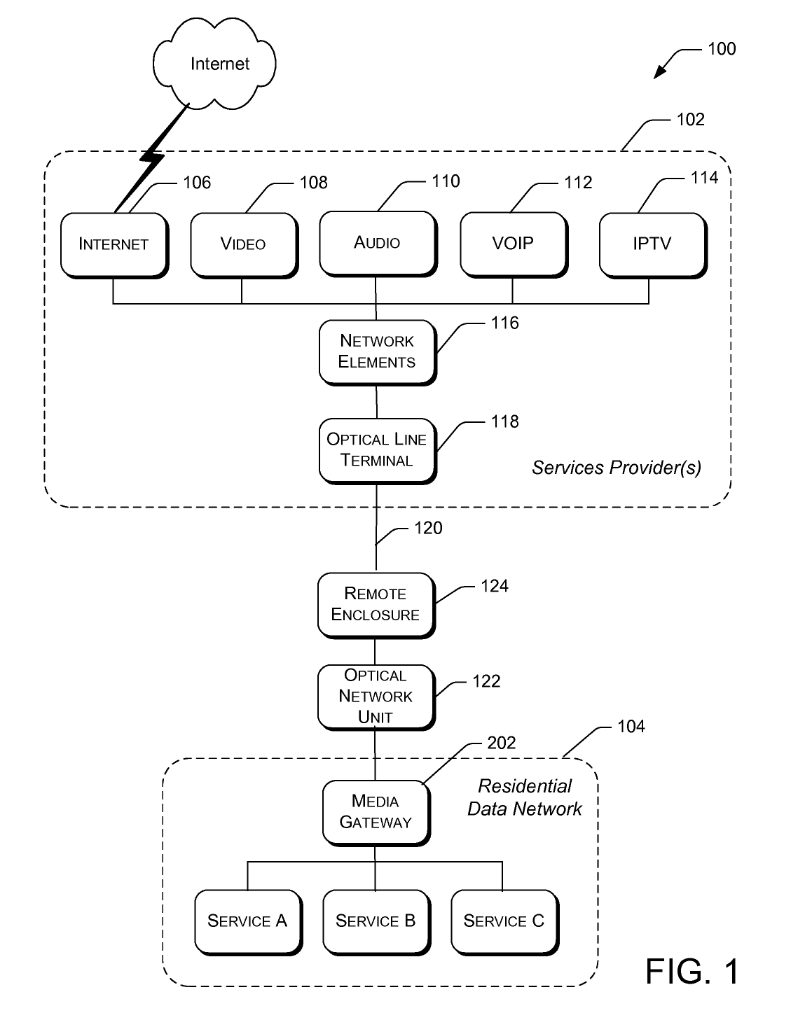

FIG. 1 illustrates a wide area network 100 to provide or deliver digital services and content to a home or residential data network 104. One or more service provider(s) 102 may provide a variety of services and digital content such as broadband internet 106, digital video 108, digital audio 110, voice over internet protocol 112, internet protocol television 114, and the like. The services and content may be connected to one or more network elements 116 which aggregates and distributes the services and content to the customer.

In one implementation, a passive optical network (PON) connects the service provider(s) 102 with the residential data network 104. The passive optical network may include an optical line terminal (OLT) 118, optical fiber 120, and one or more optical network units (ONU) 122. The optical line terminal 118 controls the transmission of services and data to the optical network unit 122, which in turn converts the transmission signal from optical to an electrical format. Generally, optical networks split the optical fiber 120 into individual fibers or fiber bundles in remote enclosures 124 located at various points in the optical network. Typically, the fiber bundle is split into 32, 64, or up to 128 individual fibers. The individual fibers are then routed to an optical network unit 122 located proximate the home or residence. The service provider 102 transmits digital services and data from the OLT 118, down the optical fiber 120, to the ONU 122, which converts the optical signal to an electrical signal. A media gateway 202 then receives the services and data and distributes them throughout the residential data network 104. In another embodiment, the optical fiber 120 may terminate at the media gateway 202 of the residential data network 104, eliminating the need for a separate ONU 122. The media gateway 202 may include one or more devices to perform the function of converting an optical signal to an electrical signal.

Although a passive optical network has been shown and described, other networks may be employed. For example, a wired or a wireless network may be used in addition to or instead of the passive optical network.

### Illustrative Residential Data Network

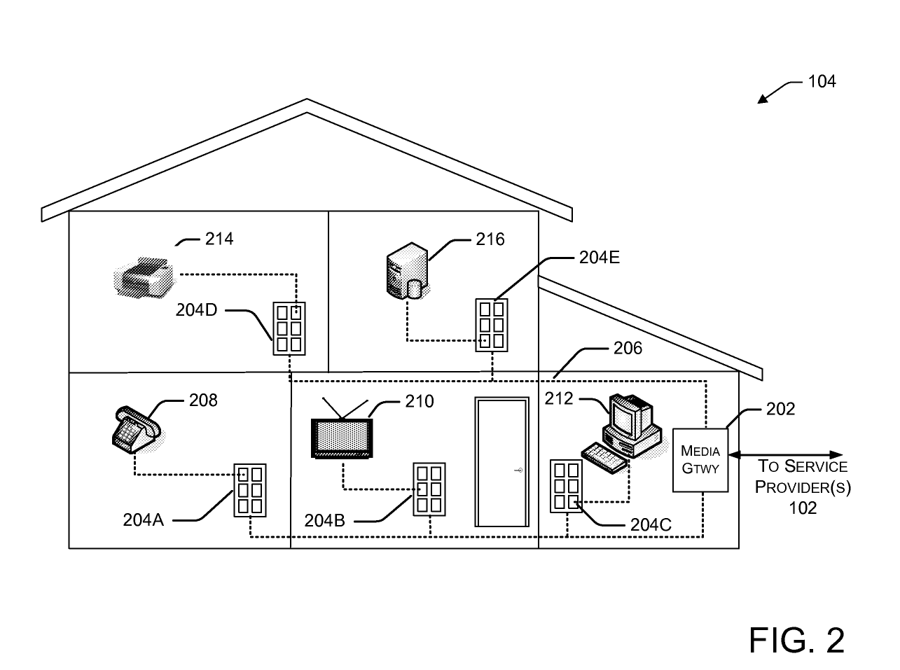

FIG. 2 depicts a schematic of a home or residence with a residential data network 104 capable of distributing and managing network services and content. The illustrative residential data network 104 generally includes a media gateway 202, a number of outlets 204 A-E distributed throughout the residence, and a plurality of data carriers 206 to couple the outlets 204 A-E to the media gateway 202.

In one embodiment, the media gateway 202 is configured to receive multiple services and content from multiple network service providers 102; the media gateway 202 functioning as a common service entrance available to the multiple service providers 102 to terminate service lines. The common service entrance may provide physical access as well as local or remote control of the residential data network 104 to the network service providers 102. The media gateway 202 serves as a collection point for services such as internet protocol television, voice over internet protocol voice communications, broadband internet access, satellite television, along with other forms of digital content. For example, the media gateway 202 may receive network services and content from one or more services providers 102 via data lines attached to the media gateway 202. Alternatively, the media gateway 202 may receive services and content from other sources such as a satellite dish, an RF antenna, receivers, transmitters, and the like.

In another embodiment, the media gateway 202 is configured to supply multiple network services to the multiple data outlets 204 A-E; the media gateway 202 functioning as a common distribution point available to the network installer or user. The media gateway 202, as a common distribution point, may provide physical access as well as local or remote control of the residential data network 104 to the installer/user. The media gateway 202 may include a structured wiring panel to organize and distribute the data carriers 206, and a services switch to manage the distribution of the digital content and services. Data outlets 204 A-E may be placed or distributed throughout the residence so that homeowners or residents are able to access data and services desired.

In a further embodiment, the media gateway 202 is configured to provide both a common service entrance and a common distribution point, to provide physical access and/or control of the residential data network 104 to service providers as well as installers and/or users.

As illustrated in FIG. 2, the outlets 204 A-E are distributed throughout the residence in a number of rooms. While only a single outlet 204 is depicted in each room, any number of outlets 204 may be provided in each room or portion of the residence. Additionally, the outlets 204 A-E as illustrated in FIG. 2 may be physical connection points, or they may be virtual access points as in a wireless network. For purposes of illustration, outlet 204A is shown connected to a telephone 208 which may provide voice over internet protocol communications. Outlet 204B is shown connected to a display device 210, such as a television set, which may provide internet protocol television, streaming video, pay per view programming, or other forms or formats of digital video. Outlet 204C is shown coupled to a computing device 212, such as a personal computer, desktop computer, laptop computer, or the like, which may receive broadband internet and other forms of digital content. In one implementation, the computing device 212 may be employed to control or monitor the media gateway 202 remotely through a software application, and may employ a graphical user interface. Outlet 204D is shown connected to a network printer 214 which may print jobs sent to it by the other devices attached to the residential data network 104. Finally, outlet 204E is shown coupled to a server 116 or other storage device which processes, stores, and delivers digital content to the devices residing on the network 104. These illustrations are not intended to be all inclusive, and are only a few examples of many possible connections to a residential data network 104.

In one implementation, the data carriers 206 comprise twisted pair copper wire such as category 5 cable (Cat 5). In an alternate implementation, the data carriers 206 may include a wireless communications media such as acoustic, RF, infrared, and/or other suitable wireless media. In a further implementation, the data carriers 206 may include optical fiber or alternate forms of optical data transmission. Moreover, combinations of any of the above are also included within the scope of the data carriers 206.

As will be discussed, the media gateway 202 manages the services and content distributed throughout the home or residence and may be used to select which services or data are provided to each outlet 204 along with the bandwidth provided to that outlet 204.

### Illustrative Services Switch Functionality

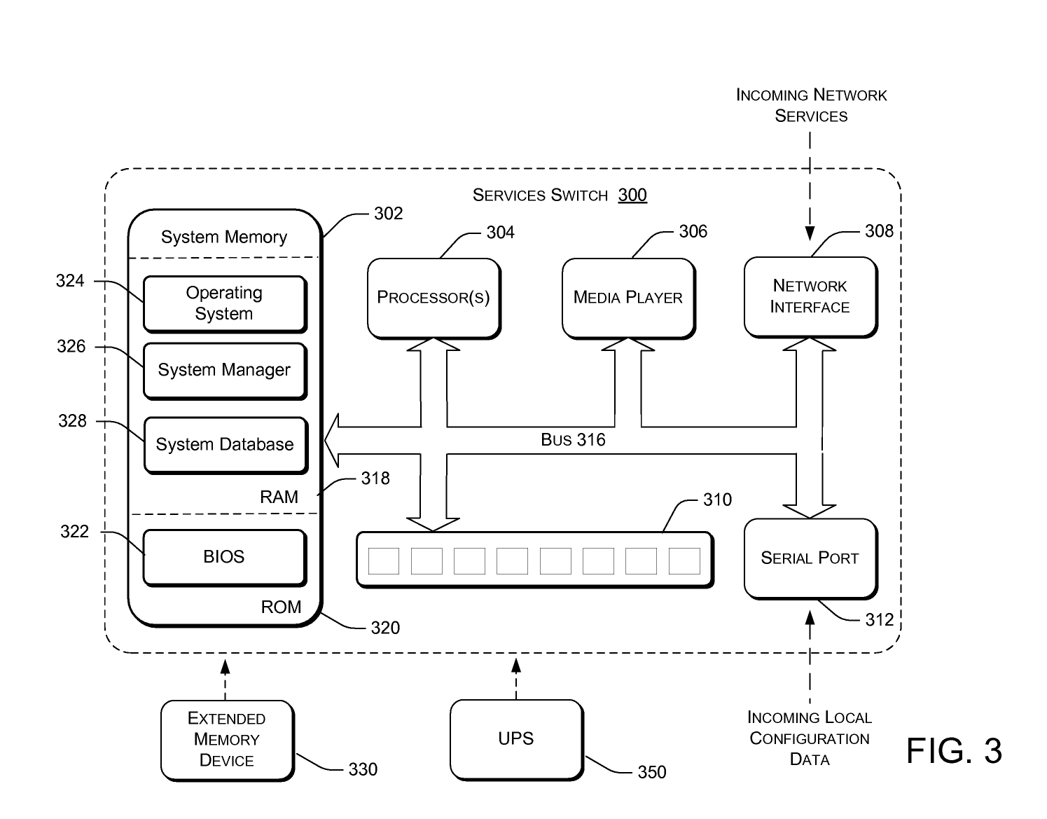

FIG. 3 illustrates a block diagram of an exemplary services switch 300 to manage and distribute digital services and content throughout the home or residence. The services switch 300 may include system memory 302, one or more processor(s) 304, a media decoder 306, a network interface 308, one or more data ports 310, and a serial port 312.

The system memory 302 may include computer readable memory in the form of volatile memory, such as random access memory (RAM) 318 and/or non-volatile memory, such as read only memory (ROM) 320. A basic input/output system (BIOS) 322, containing basic routines that help to transfer information between elements within the services switch 300, such as during startup, may be stored in ROM 320. RAM 318 contains data and/or program modules that are assessable and operated by the processor(s) 304. One or more extended memory devices 330 may also be attached, including hard disk drives, optical drives, solid state memory devices, and the like.

Any number of program modules can be stored in system memory 302, including by way of example, an operating system 324, a system manager 326, and a system database 328.

The processor(s) 304 utilizes the operating system 324 to provide control over the services switch 300. Additionally, through the operating system 324, the processor 304 accesses the system manager 326, which functions to control the allocation of services, content, and bandwidth distributed by the services switch 300 to the outlets 204. The system manager 326 utilizes rules stored in the system database 328 to perform distribution and allocation tasks.

The services switch 300 may also include a media decoder 306 to convert services and content into video, audio, images, and other data for distribution throughout the residential data network 104. A media decoder 306 may be a software application that manages a broad range of multimedia related tasks. For example, the media decoder 306 may handle various forms of digital media content (e.g., audio files, video files, image files, etc.). The media decoder 306 may also offer various broadband services such as internet radio, internet protocol television, voice over internet protocol, and the like. For example, the media decoder 306 may function as a radio tuner, a television tuner, a video decoder (e.g., MPEG-2 and MPEG-4), a video capture device, or other similar functions.

In one implementation, the media decoder 306 may be located on a separate expansion card that may plug into a slot in the services switch 300 or alternatively the media decoder 306 may be integrated, for example, into the services switch's chip set.

The services switch 300 is connected to one or more service provider lines via the network interface 308. The service provider lines may include a telephone service line, a cable television line, a broadband internet line, an RF antenna, a satellite dish, or other services.

The services switch 300 may also include a plurality of data ports 310 to distribute internet protocol television, voice over internet protocol, broadband internet, and/or other forms and formats of services and content to the residence. The data ports 310 may include a variety of different configurations including: 8 position 8 contact connectors (e.g., RJ45), coaxial connectors, fiber optic connectors, and the like. In one embodiment, the data ports 310 may be mounted toward the front of the services switch 300 so that they are easily accessible by a technician, installer, or the home owner. In an alternative embodiment, the data ports 310 may be located away from the front of the services switch 300 (non-visible side of the switch) such that the connections are protected from inadvertent disconnection.

In general, data ports 310 are ordinarily mounted onto a primary surface of a PCB board so that they are parallel to the primary surface of the PCB board. The primary surface of the PCB board may be commonly identified by the side or surface on which the PCB board is printed, by the side or surface on which components are mounted, and/or the largest surface of the PCB board. In cases where data ports are mounted onto a PCB board, in parallel to the primary surface of the PCB board, the data ports 310 tend to face upwards, downwards, or sideways when installed in a structured wiring panel 402. In one embodiment, the data ports 310 are mounted onto a PCB board so that they are perpendicular to the primary surface of the PCB board. The PCB board is assembled into the services switch 300, so that the data ports 310 face outwards from the front cover of the services switch, making them readily accessible to a technician, installer, or the home owner while the services switch is mounted within the structured wiring panel 402.

A homeowner may input commands and/or information to the services switch 300 via a serial port 212. For example, a homeowner may connect a laptop computer, personal digital assistant (PDA), or other peripheral device to the services switch 300 using a RS-232 interface, FireWire, Universal Service Bus (USB), Ethernet, or any other suitable communications interface. Once a connection is established, the homeowner may configure the services switch 300 by inputting commands via a pointing device (e.g., a mouse, a stylus, etc.), a keyboard, or any other suitable input device. In one embodiment, the homeowner may configure the services switch 300 by using a graphical user interface. Alternatively, the homeowner may use the serial port 212 to monitor the switch's performance (e.g., bandwidth being provided to each data port), its configuration (e.g., what service is being provided to each data port), or other switch parameters that are of interest to the homeowner. Additionally, the functions discussed in this section are not meant to be limited to the homeowner exclusively, as services installers, maintenance personnel, or other interested parties with authorized access may also perform the discussed functions.

The system bus 316 may employ several different bus architectures including a memory bus or memory controller, a peripheral bus, a processor or local bus, using a variety of bus architectures as would be obvious to a person having skill in the art.

The services switch 300 may be implemented in a variety of alternate arrangements and configurations. For example, although the services switch 300 is illustrated as a number of separate components, any one or more of these components may be combined into a unitary device, or alternatively they may be configured as stand-alone components.

For example, the services switch 300 may include an uninterruptable power supply UPS 332, either coupled externally to the services switch 300, or installed within the services switch 300. The UPS 332 may be electrically coupled to the services switch 300, and in one embodiment, the UPS supplies backup electrical power to the services switch 300, and/or to devices coupled to the residential data network 104, as described in the sections below.

In an alternate embodiment, a number of services switches 300 may be coupled together for increased capacity. For example, if the residential data network requires a greater number of data ports 310 than is supplied by a single services switch 300, two or more services switches may be coupled together in a cascade formation, thereby expanding the number of available data ports 310 to be employed in the residential data network 104.

Further, in one embodiment, the services switch 300 is installed at the residence so that it is physically accessible from within the residence. This has the advantage of allowing the homeowner or resident to configure the services switch 300 as desired, as well as providing security against vandalism and protection from the weather. The services switch 300 may be installed in an enclosure as discussed in sections below, where the enclosure may also be installed at the residence so that it is physically accessible from within the residence.

### Illustrative Media Gateway Features

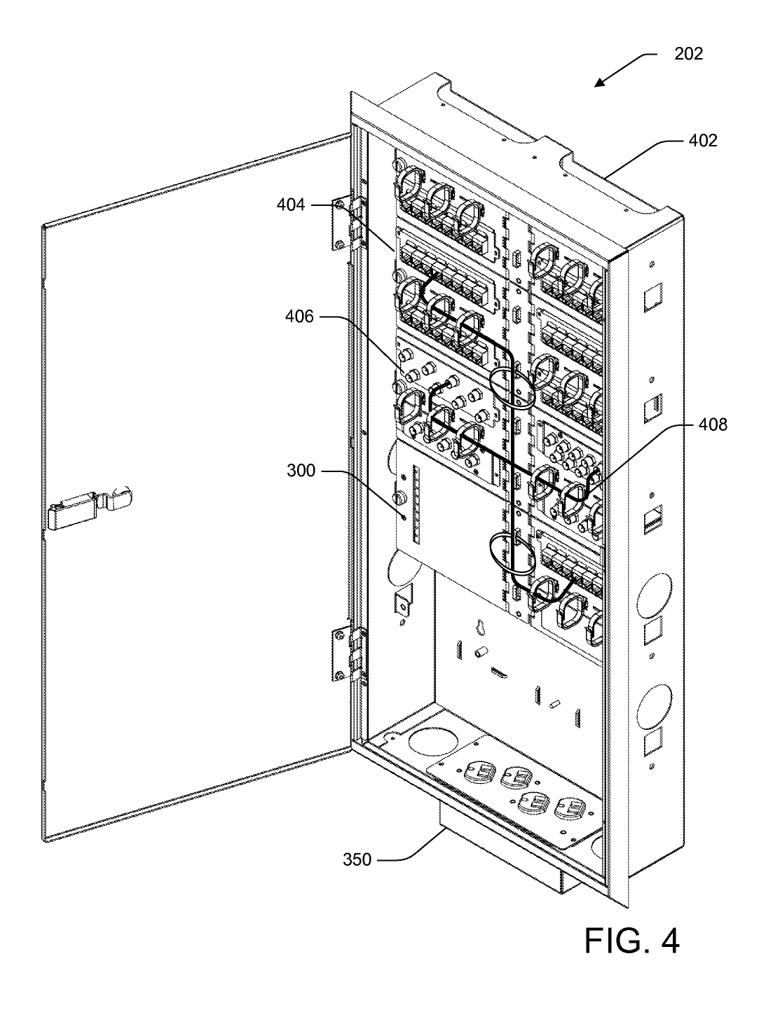

FIG. 4 is a perspective view of the media gateway 202 in more detail. The media gateway 202 may receive multiple services and content from one or more service providers 102. The media gateway 202 may function as a common service entrance to terminate service lines, as well as a common distribution point to provide access to the multiple services received. In one embodiment, the media gateway 202 is configured to mechanically and electrically terminate network service transmission lines. In another embodiment, the media gateway 202 is configured to mechanically and optically terminate network service transmission lines. In this example, the media gateway 202 includes a structured wiring panel 402, a services switch 300, one or more patch panels 404, and an uninterruptable power supply (UPS) 332.

The structured wiring panel 402 is illustrated as being substantially rectangular in shape and comprising four substantially planar walls, a back panel, and a front access panel. In one implementation, the patch panels 404, services switch 300, and uninterruptable power supply 332 are arranged in a stacked configuration, with each component being placed substantially above or below another component. In a further implementation, the patch panels 404, services switch 300, and uninterruptable power supply 332 are configured in a substantially planar configuration and the components are substantially adjacent to one another.

In other implementations the structured wiring panel 402 may have a greater or lesser number of walls. For example, the four substantially planar walls of the panel may be omitted, and the media gateway 202 comprises a substantially open frame work. As mentioned above, the media gateway 202, including the structured wiring panel 402, may be installed at the residence so that it is physically accessible from within the residence. This has the benefits of allowing the homeowner or resident to configure the devices included in the media gateway 202 as desired, as well as providing security against vandalism and protection from the weather. In one embodiment, the media gateway 202 is mounted partially within the residence. In another embodiment, the media gateway 202 is mounted completely within the residence.

In one embodiment, the structured wiring panel 402 houses the services switch 300, the patch panels 404, and the uninterruptable power supply 410. In other embodiments, the structured wiring panel 402 may house only a portion of the components mentioned, or none of them. In further embodiments, other devices and components are also included within the structured wiring panel 402 to comprise the media gateway 202.

The media gateway 202 may have a variety of different patch panels 404 which may include a variety of signal connectors 406 (e.g., RJ45 connectors, coaxial connectors, optical fiber connectors, to name a few), amplifiers, splitters, combiners, power receptacles, cover plates, or any other suitable structured wiring component.

Power over Ethernet and Backup Uninterruptable Power Supply (UPS)

The media gateway 202 may supply electrical power, in addition to data, to devices coupled to the residential data network 104 by way of the data carriers 206 coupled to the services switch 300. This technique is commonly referred to as Power over Ethernet (PoE). A portion of the output data ports 310 available on the services switch 300 may supply PoE to connected devices. Devices receiving PoE from the services switch 300 may include VoIP telephones, home security devices, wireless access points, thermostats, and the like.

In one embodiment, PoE is supplied by the services switch 300 on RJ45 type data ports. Two of the four available pairs of conductors on the RJ45 type data ports may supply at least 48 Volts DC to a connected device. In another embodiment, PoE is supplied by the services switch 300 on an optical small form-factor pluggable (SFP) data connection.

In an exemplary embodiment, electrical power is available at a designated data port 310 of the services switch 300. The electrical power may be transmitted by patch cables 408 and data carriers 206 coupled to the data port 310, and may terminate at an outlet 204. The electrical power is then available for use by a device coupled to the outlet 204. In one embodiment, a network operator or a homeowner may locally or remotely designate one or more data ports 310 on the services switch 300 to supply PoE to one or more of the outlets 204 in the residential data network 104.

The patch panels 404, services switch 300, and other components are functionally coupled together using patch cables 408. The patch cables 408 may include twisted pair copper patch cables, coaxial cables, optical fiber patch cables, or any other cables suitable for coupling the components. The patch cables 408 transmit the services and content from the services switch 300 to the patch panels 404, wherein the services and content are distributed throughout the residence. In an alternate embodiment, the services and content are distributed directly from the services switch 300 to the data outlets 204 A-E.

The media gateway 202 may also include an uninterruptible power supply (UPS) 332 to provide backup electrical power to the services switch 300 in the event of a main power failure or other unanticipated event. The UPS 332 may be implemented as an off-line UPS, which remains idle until the power failure occurs and then switches from utility power to its own internal power source. Alternatively, the UPS 332 may be implemented as an on-line UPS, which continuously powers the services switch 300 from internal power source (e.g., typically a battery), while simultaneously replenishing the backup reserves from utility power. Moreover, the UPS 332 may include circuitry to safeguard the media gateway 202 from typical utility power problems (e.g., power spikes).

In one embodiment, the UPS 332 may supply backup electrical power to one or more of the data ports 310 supplying PoE. The UPS 332 may supply electrical power over the data carriers 206 to devices coupled to the residential data network 104 in the event of a main power failure. Backup power may be supplied on a priority basis if limited backup power is available, or if there is not enough capacity to supply backup power to all devices coupled to the residential data network 104 at once. In one embodiment, only the one or more data ports 310 with the highest priority receive backup electrical power from the UPS 332 in the event of a main power failure. Data ports 310 coupled to critical systems may be designated to have the highest priority, and receive backup electrical power from the UPS 332 during a main power failure. Critical systems may include such systems as telephone service such as VoIP service, or security devices. In one embodiment, a network operator and/or a homeowner may locally or remotely designate one or more data ports 310 on the services switch 300 to have the highest priority, and to receive backup electrical power from the UPS 332 in the event of a main power failure. The network operator and/or homeowner may designate the one or more data ports 310 on the services switch 300 intended to have highest priority, and/or intended to receive backup electrical power from the UPS 332 by entering rules into the system database 328.

### Illustrative Services Switch Features

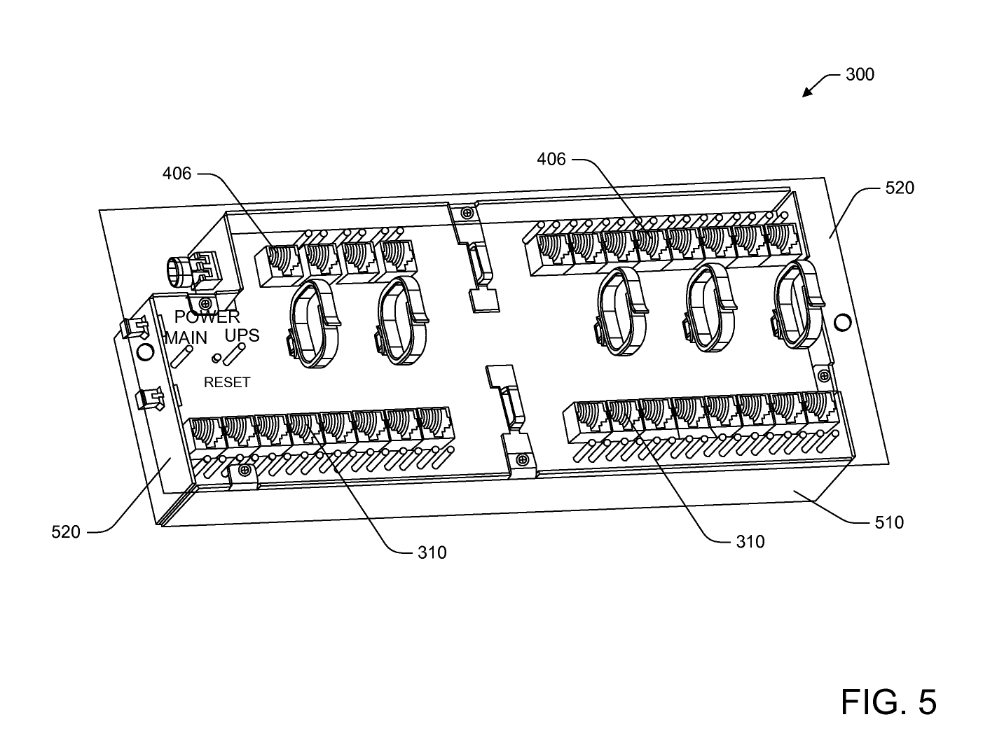

FIG. 5 is a perspective view illustrating the services switch 300. The services switch 300 may be dimensioned such that it will fit into the structured wiring panel 402, as shown in FIG. 4. The dimensions for the services switch may be in the range of 11-14 inches wide by 4-7 inches tall by 1-3 inches deep, excluding a front cover and mounting ears. In another embodiment, the services switch may be dimensioned as approximately 12.7″ wide by 5.2″ tall by 1.8″ deep, excluding a front cover and mounting ears. The services switch includes a chassis 510 configured for installation into structured wiring panel 402, including mounting ears 520.

When service or content is received by the media gateway 202, the service is received by the services switch's 300 network interface 308. The services switch 300 then distributes the service to the appropriate data port 310, where the service is conveyed to the appropriate patch panel 404 via a patch cable 408. From the patch panel 404, the service is conveyed to the appropriate data carrier 206 via one or more signal connectors 406, and the service terminates at the selected outlet 204.

In one embodiment, the services switch 300 includes at least four communications ports (signal connectors 406) configured to deliver Gigabit Ethernet (1000 Base-T). In another embodiment, the services switch 300 includes at least twenty-four communications ports (signal connectors 406) configured to deliver Fast Ethernet (100 Base-TX). In other embodiments, other amounts of communications ports (signal connectors 406) are available on the services switch 300 to deliver other formats and speeds of data.

As noted, the signal connectors 406 may be in a variety of different configurations and include various connectors (e.g., RJ45 connectors, coaxial connectors, or optical fiber connectors, to name a few). To connect the media gateway 202 to the residential data network 104, various data carriers 206 are coupled at one end to a signal connector 406 at the media gateway 202, and are coupled at the other end to one or more outlets 204 throughout the residence. This establishes a correspondence between a signal connector 406, and one or more outlets 204, such that a device coupled to an outlet 204 may be communicated with or controlled through the corresponding signal connector 406. The data carriers 206 may comprise coaxial cable, twisted pair copper lines, optical fiber cable, wireless circuits, or the like.

In one embodiment, the signal connectors 406 are mounted on a PCB board so that they are perpendicular to the PCB board. The PCB board is assembled into the services switch 300, so that the signal connectors 406 face outwards from the front cover of the services switch, making them readily accessible to a technician, installer, or the home owner while the services switch is mounted within the structured wiring panel 402.

As noted, the services switch 300 includes one or more network interfaces 308 to receive services and content from a variety of sources. By way of example and not limitation, the services switch 300 may receive telephone service, cable television service, and/or broadband internet service. Alternatively, the services switch may receive services and content from an RF antenna, a satellite dish, or other source of content coupled to the home or residence. Multiple services may be delivered to the services switch 300 over a single service provider line, or multiple services may be delivered over multiple lines. Additionally, multiple services may be delivered over a number of different types of lines including but not limited to coaxial cable, twisted pair copper lines, optical fiber cable, wireless transmission, and the like.

In addition to distributing services and content throughout the residence, the services switch 300 may also be configured to manage the delivery of the services and content to the various outlets 204. The processor(s) 304, system memory 302, and media decoder 306 allow the services switch 300 to send selected services and content to particular outlets 204 throughout the residence.

First, the services switch 300 may determine which services and content are to be delivered to each outlet 204 based on a set of established rules and/or homeowner inputs. Additionally, the services switch 300 may determine a priority hierarchy for each outlet 204 to provide each outlet 204 with the appropriate bandwidth according to its priority at a given time, and under given circumstances. Finally, once the priority and content for a specific outlet 204 are established, the services switch 300 may monitor the services and content being transmitted to that outlet 204. Monitoring may include monitoring for such things as connectivity or performance.

### Examples of Programming and Prioritizing

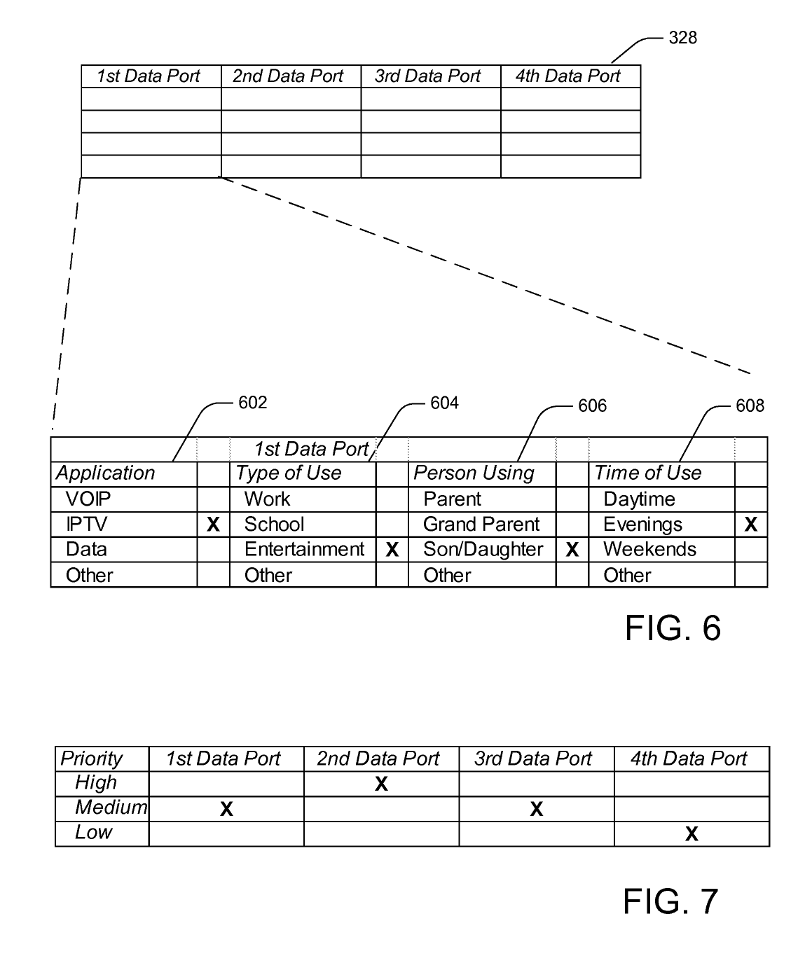

FIGS. 6 and 7 illustrate how a homeowner or resident may program the services switch 300 to manage the services and content being distributed throughout the residence. The homeowner or resident may enter the appropriate rules or commands into the switch 300 using one or more application programs that reside in system memory 302. For example, the homeowner or resident may connect a laptop computer, personal digital assistant (PDA), or other peripheral device to the services switch 300 through serial port 212, or interface with the services switch 300 by connecting to an outlet 204 with similar devices. Additionally, the functions discussed in this section are not meant to be limited to the homeowner or resident exclusively, as services installers, maintenance personnel, or other interested parties with authorized access may also perform the discussed functions. For example, a network operator may program the services switch 300 to manage the services and content being distributed throughout the residence. The network operator may program the services switch 300 locally by connecting a device directly to the serial port 212 of the services switch 300, or may program the services switch 300 from a remote location such as a network operations center using, for example, a network services transmission line or an internet connection.

FIG. 6 illustrates one example of how rules may be programmed into the services switch's 300 system database 328. As shown in FIG. 6, each column in the database may represent a set of criteria that may be used to manage the services and content provided to a specific data port 310. In the example shown, a rule for the “1^{st} Data Port” is programmed into the services switch's 300 system database 328 by placing an “X” in an appropriate field for each criterion. Alternatively, the fields in the database 328 may be completed using a pull down menu, a series of buttons, a series of check boxes, or any other means of inputting data. The first column 602 in this example indicates the type of service or content that is to be delivered to the 1^{st} Data Port. In this example, voice over internet protocol (VoIP), internet protocol television (IPTV), digital data, and other types of services or content are available to be delivered to this particular output port. The second column 506 indicates how the services and data at this port will be used. For example, they may be used to perform work, such as part of a home-based business; they may be used for school or studies, for entertainment, or for other uses. The third column 606 indicates who will be using the services or content being provided by the media gateway 202 to the 1^{st} Data Port. The example shows a selection of possible family members. Finally, the forth column 608 indicates when the services or data will generally be used (e.g., time, date, shift, to name a few). Other categories may be created in the database 328, and used to create rules in like manner.

Making selections in the particular fields in the database 328 creates rules for an associated data port 310, in this example the 1^{st} Data Port. The selection process described is repeated as necessary for each data port 310 in the residential data network 104. The process can be further repeated as necessary to reprogram the rules for delivery of content and services to one or more of the data ports 310 as circumstances change.

Once created, the rules are used by the services switch 300 to determine the content and services to be delivered to each particular data port 310. The services switch 300 delivers the services and content according to the rules created by the homeowner, network operator, or other interested party with authorized access.

The services switch 300 may prioritize the services and content being sent to each data port 310. In one embodiment, the services switch 300 may use the programmed rules to determine which data port 310 has priority to receive content or services if there is a conflict among the data ports 310, or limited bandwidth available. The services switch may base the priority of the data ports 310 on the programmed type of use 604 of the data ports 310. For example, services delivered to one data port 310 may be less affected by a drop or delay in service than services at another data port 310. While a simple lag in the transmission of broadband data may not be objectionable or even noticeable to a user, conversations that employ VoIP may be difficult to understand if the signal drops off mid-sentence or there is a delay in a response. Accordingly, a data port 310 that is programmed to receive VoIP transmissions may have a higher priority than a data port 310 receiving broadband data. Similarly, a data port 310 programmed to deliver high-speed internet services for a home-based business may have a higher priority than a data port 310 that provides services and content for entertainment purposes.

In another embodiment, the services switch 300 may prioritize the services and content being sent to each data port 310 based on who 606 will likely be using the data port 310. Consequently, a parent, adult, or guardian may have a greater or more urgent need for internet services than a minor child. Thus, a data port 310 programmed for use by adults may have a higher priority than a data port 310 programmed for use by minor children.

In a further embodiment, the services switch 300 may prioritize the services and content being sent to each data port 310 based on the time or shift 608 that the services or content will be used. For example, the services switch 300 may determine that a data port 310 in a family room, providing online gaming, IPTV, or other forms of online entertainment, may receive greater bandwidth priority in the evenings when the services and content from the data port 310 will receive the most use.

FIG. 7 illustrates a possible set of priorities for four data ports illustrated in FIG. 6. In FIG. 7 the “X's” indicate the relative priority of the various data ports based on rules selected by a resident or homeowner. In this example, the second data port has the highest priority and receives priority over the other output ports in cases of conflict or limited bandwidth. Similarly, the first and third data ports have medium priority and receive priority over the forth data port. In this example, the priority of each data port is indicated by high, medium, and low. Alternatively, a data port's priority may be indicated by a letter score (e.g., A, B, C), a numerical score (e.g., 1, 2, 3), or any other means of indicating priority.

In an alternate embodiment, the priorities determined for the various data ports 310 may be overridden by a resident or homeowner. The resident may assign an overriding priority for one or more data ports 310 that takes precedence over the rules determining priority. For example, the aforementioned data port 310 serving a home-based business may be assigned an override priority, and always have the highest priority over all of the other data ports 310.

In a further embodiment, the priorities for the various data ports 310 may be determined by billing rules. For example, a network operator may apply rules that correspond to usage times or other conditions effecting efficiency of the network, or maximizing resources. For instance, such priorities may favor a resource such as high-speed internet service during the night, to take advantage of available bandwidth for large downloads or automatic system upgrades. Priorities based on billing rules may vary throughout the day. Further, the billing rules applied by the network operator may be overridden in emergencies.

Once a device has been coupled to the residential data network 104, the services switch 300 may query the system database 328 to determine which services or content 106-114 to provide to the device. Alternatively, the services switch 300 may listen to Internet Group Management Protocol (IGMP) conversations between network element 116 (e.g., level 3 router) which provides services or content 106-114 to the device recently coupled to the residential data network 104. When the services switch 300 hears a “group join” message from the device, it notes which switch interface it heard the message on, and adds that interface to the group receiving the service. Similarly, when the services switch 300 hears a “group leave message,” or a response timer expires, the services switch 300 removes the device switch interface from the group.

Once the services switch 300 has determined which services or content are being provided to the data port 310, it may apply the programmed rules to determine its priority (e.g., application 602, type of use 604, person using 606, time of use 608, etc.). Alternatively, as described above, a homeowner or resident may enter an override priority for the data port 310.

### Illustrative Apportionment of Bandwidth

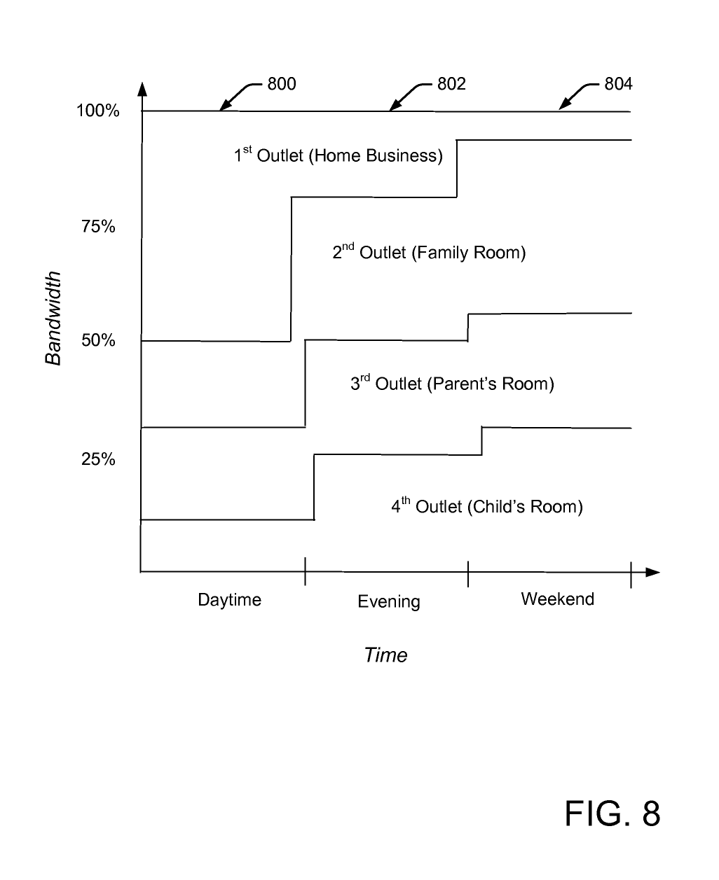

FIG. 8 illustrates how the services switch 300 may optimize the apportionment of available bandwidth to a group of residential outlets 204. The outlets 204 are illustrated in FIG. 8 as locations within the residence, and are each shown having a percentage of the total bandwidth available, which varies by time of day. In one embodiment, once the services switch 300 has determined a priority for each data port, it provides each data port (e.g., residential outlet 204) with appropriate bandwidth based on that priority. For example, a first outlet 204 may provide services and data to a home-based business. The business may require internet access to contact customers, order goods, or respond to requests for goods and services. Since a business may take priority over entertainment or leisure activities, the outlet 204 serving the business may receive the greatest amount of bandwidth. This may be the case during normal business operating hours 800. However, outside of normal business hours 802 (i.e., evenings), a new set of rules may apply, and the home-based business may lose its priority to other activities (e.g., school projects, talking with friends and family, watching the news, etc.). Moreover, on the weekends 804, a third set of rules may apply. For example, entertainment and leisure activities (e.g., watching movies, on-line gaming, etc.) may become the highest priority and receive the greatest amount of bandwidth. It should be appreciated that this is simply one example of how a services switch 300 may manage a residential data network 104 and is not intended to limit the technique, manner, or method of managing a residential data network 104. Additionally, as described above, a homeowner or resident may enter an override priority for any data port 310, granting one or more outlets 204 bandwidth priority, and overriding the programmed rules.

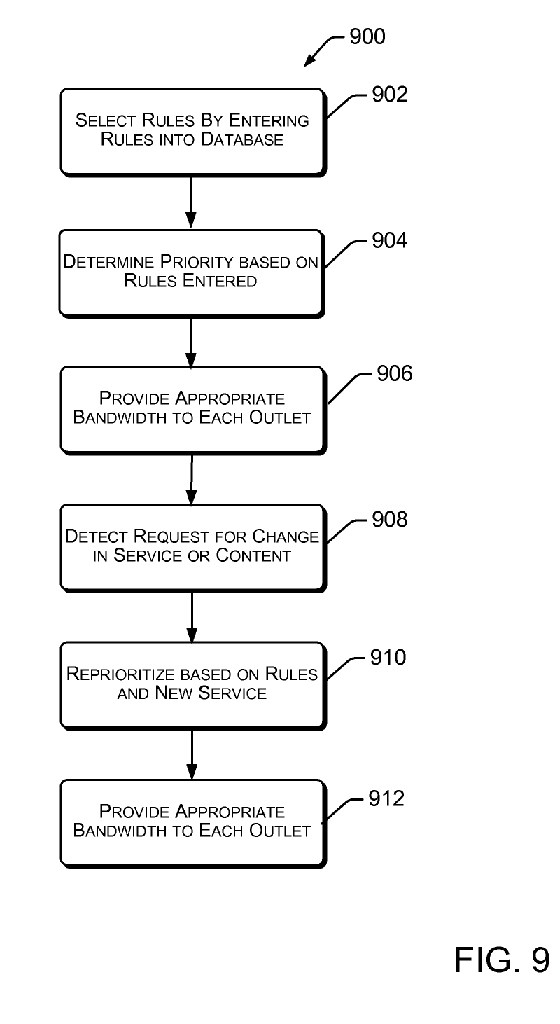

An exemplary method of managing a residential data network 900 will now be described with reference to FIG. 9. While one or more methods are disclosed, the elements of the described methods do not have to be performed in the order in which they are presented and an alternate order may result in similar advantages. Moreover, the methods are not exclusive and can be performed alone or in combination with one another. The described method may be performed by any appropriate means including, for example, by execution of processor-readable instructions recorded on a processor-readable storage medium.

In one embodiment, a method of managing the bandwidth of a residential data network 900 is illustrated. At block 902 a homeowner or resident selects rules for a residential data network 900 by entering appropriate rules 602-608 into a system database 328 through a system manager 326. The resident may interface with the residential data network 900 by a variety of methods, including connecting a programming device to the services switch's serial port 312, one of the data ports 310, one of the outlets 204, or connecting remotely (e.g., services provider site). As discussed previously, the rules selected may include determinations regarding the types of services to be provided to particular outlets 204, the use of the services, the persons using the services, and the times the services are used.

At block 904, a services switch 300 determines a relative priority for each data port based on the rules entered. A data port's priority may be designated using a high, medium, or low score, a numerical score (e.g., 1-10), a letter score (e.g., A, B, C, etc.), a star score, or any other designation of priority.

At block 906, the services switch 300 provides appropriate bandwidth to each outlet 204 based on its determined relative priority. The services switch 300 allocates portions of the available bandwidth to the outlets 204 in such a manner as to preclude degradation of quality of service to the outlets 204 having higher priorities. Further, the services switch 300 makes adjustments to the allocation of bandwidth to the outlets 204 as necessary when priority changes occur among the outlets 204.

At block 908, the services switch 300 may detect a networked device's 208-216 requests for new services or form of content. In one embodiment, the services switch 300 may detect a change request by listening to the Internet Group Management Protocol (IGMP) conversations between the network elements 116 (e.g., level 3 router) providing the service and the networked device 208-216 receiving the service.

At block 910, the services switch 300 determines a new priority for an outlet 204 having new services or content provided to the outlet 204. Depending upon the outlet's previous priority and the new services/content being provided, the outlet's new priority may be higher, lower, or the same as the previous priority. Alternatively, the services switch 300 may determine a new priority for an outlet 204 based on changes to the rules 602-608, or an override to the rules 602-608 entered by the resident or homeowner.

At block 912, the services switch 300 provides appropriate bandwidth to each outlet 204 based on its determined relative priority, in light of any changes to the services provided to the outlet 204, or to the rules governing the priority of the outlet 204.

### Illustrative Backup Power Implementation

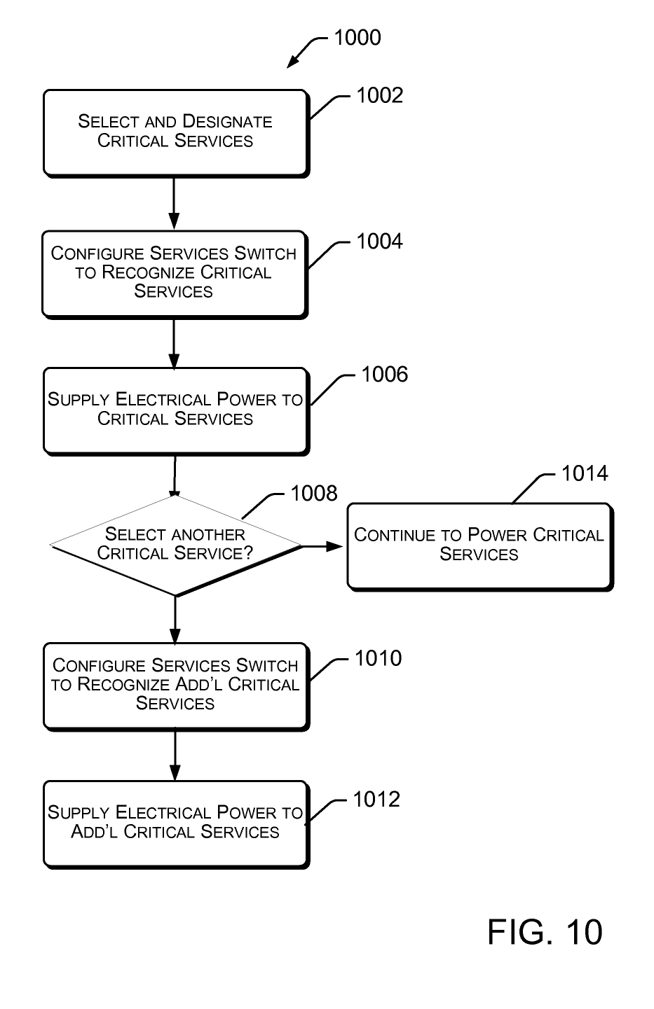

FIG. 10 illustrates selecting, configuring and powering a critical service on an example residential data network 1000. A critical service may be one that is determined to have the highest priority for continued operation in the event of an emergency, a main power failure, or similar occurrence. Critical systems may include telephone service such as VoIP service, security systems and devices, automatic sprinkler control systems, and the like.

At block 1002, the network programmer or homeowner selects and designates critical services among all of the available services coupled to the residential data network 1000. The designations may be stored in the system memory 302 of the services switch 300. In one embodiment, the network programmer or homeowner may select and designate which of the available services are critical services by entering rules into the system database 328.

At block 1004, the network programmer or homeowner configures the services switch 300 to recognize the critical services. Configuration may include coupling the critical services to data ports 310 which supply power over Ethernet (PoE). Additionally, configuring may include creating rules via the system database 328, establishing a high priority for the data ports 310 with critical services connected. Further, configuring may include providing backup electrical power to the data ports 310 serving critical services. Configuring may include any other activity to allow the services switch 300 to distinguish the critical services from the other available services on the residential data network 1000.

At block 1006, the services switch 300 supplies electrical power to the critical services. This may include supplying PoE, supplying backup electrical power from a UPS 332, or the like.

At block 1008, if there are additional critical services which have been selected but not yet configured or powered then the steps continue to block 1010 for additional configuration. However, if all selected critical services have been configured and powered, the services switch 300 continues to power the critical services configured at block 1014.

At block 1010, the network programmer or homeowner configures the services switch 300 to recognize additionally selected critical services. Alternately, the network programmer or homeowner reconfigures the services switch 300 to recognize different critical services, if the network programmer or homeowner changes previous selections of critical services among the available services.

At block 1012, the services switch 300 supplies electrical power to the additional or newly determined critical services.

### CONCLUSION

Although implementations have been described in language specific to structural features and/or methodological acts, it is to be understood that the invention defined in the appended Claims is not necessarily limited to the specific features or acts described. Rather, the specific features and acts are disclosed as illustrative forms of implementing the Claimed invention.

What is claimed is:

1. A media gateway to distribute network services and content to a residence, the media gateway comprising:
a services switch located at the residence to receive a plurality of network services from one or more network service providers, and to distribute the plurality of network services to a plurality of data outlets located at the residence, the services switch comprising:
one or more processors;
a network interface to receive instructions;
a system database to store the received instructions; and
a system manager executable by the processor to (i) selectively distribute the plurality of network services to the plurality of data outlets based on the received instructions, and (ii) selectively apportion available bandwidth to each of the plurality of data outlets based on the received instructions.

2. The media gateway of claim 1, wherein the network interface includes an input to receive instructions from one or more of the network service providers over one or more network transmission lines.

3. The media gateway of claim 1, wherein the network interface includes an input to receive instructions from a resident or user of the media gateway.

4. The media gateway of claim 1, wherein the media gateway is configured to terminate network service transmission lines.

5. The media gateway of claim 1, wherein the media gateway is configured to convert optical signals to electrical signals.

6. The media gateway of claim 1, wherein the media gateway comprises one or more media decoders, the media decoders configured to convert the plurality of network services into one or more of video or audio signals.

7. The media gateway of claim 1, wherein the media gateway is configured to transmit power over Ethernet (PoE) to devices coupled to one or more of the data outlets.

8. The media gateway of claim 1, further comprising an uninterruptable power supply (UPS) to supply backup power to one or more of the data outlets in an event of main power failure.

9. The media gateway of claim 8, wherein the backup power is supplied to the data outlets by power over Ethernet (PoE).

10. The media gateway of claim 8, wherein the backup power is supplied to the data outlets based on a priority of the data outlets.

11. The media gateway of claim 10, wherein the priority of the data outlets is based on the received instructions.

12. The media gateway of claim 10, wherein the priority of the data outlets is based on one or more of: an application of each of the plurality of network services, a use of the plurality of network services, a person using the plurality of network services, a location of the data outlet, or a time of day.

13. The media gateway of claim 10, wherein the priority of the data outlets is based on billing rules applied by a network service provider.

14. The media gateway of claim 1, wherein the media gateway is configured to monitor the performance of distribution of the plurality of network services to the plurality of data outlets based on the received instructions, and wherein the media gateway is configured to monitor the performance of apportioning available bandwidth to the plurality of data outlets based on the received instructions.

15. A method of managing bandwidth in a residential data network, the method comprising:
receiving a plurality of network services at a media gateway located at a residence, the plurality of network services being received from one or more network service providers, wherein the media gateway is configured to distribute the plurality of network services to a plurality of data outlets located at the residence;
receiving rules associated with the media gateway, the rules specifying which of the plurality of network services to distribute to each of the plurality of data outlets; and
distributing network services and content to each of the plurality of data outlets, based on the received rules.

16. The method of claim 15, wherein the rules assign each of the plurality of data outlets a priority for receiving available bandwidth, and the rules further specify what portion of the available bandwidth to apportion to each of the plurality of data outlets.

17. The method of claim 16, further comprising apportioning bandwidth to each of the plurality of data outlets, based on the priority determined for the data outlet, and based on the received rules.

18. The method of claim 15, wherein the rules are received from one or more of the network service providers.

19. The method of claim 15, wherein the rules are received from an entity remote from the media gateway.

20. The method of claim 15, wherein the rules are received as user input from one or more user devices on the residential data network.

21. A method of supplying backup electrical power to devices in a residential data network, the method comprising:
receiving a plurality of network services at a media gateway located at a residence, the plurality of network services being received from one or more network service providers, wherein the media gateway is configured to distribute the plurality of network services to a plurality of data outlets located at the residence;
receiving rules associated with the media gateway, the rules specifying which of the plurality of data outlets to supply backup electrical power to in the event of a main power failure;
selecting one or more of the plurality of the data outlets to supply backup electrical power to in the event of a main power failure, based on the rules;
assigning a priority for receiving backup electrical power to each of the selected data outlets, based on the rules; and
supplying backup electrical power to one or more of the selected data outlets, based on the priority determined for the data outlet, and based on the rules.

22. The method of claim 21, wherein supplying backup electrical power to one or more of the selected data outlets includes supplying backup electrical power by transmitting PoE to the selected data outlets from an uninterruptable power supply.

23. The method of claim 21, wherein the rules are received from one or more of the network service providers.

24. The method of claim 23, wherein the rules are received from an entity remote from the media gateway.

25. The method of claim 21, wherein the rules are received as user input from one or more user devices on the residential data network.
